(19) United States
(12) Patent Application Publication
(10) Pub. No.: US 2019/0050954 A1
(43) Pub. Date: Feb. 14, 2019

(54) METHODS FOR PROVIDING TITLE SERVICES IN A REAL ESTATE TRANSACTION

(71) Applicant: Indepth Solutions, Inc., Boise, ID (US)

(72) Inventors: Jennifer S. Perez, Boise, ID (US); Ralph D. Perez, Boise, ID (US)

(21) Appl. No.: 15/673,194

(22) Filed: Aug. 9, 2017

(51) Int. Cl. G06Q 50/16; G06Q 50/18; G06Q 30/02

(52) U.S. Cl. CPC G06Q 50/167; G06Q 30/02; G06Q 50/18

(57) ABSTRACT

A method of providing title services in a real estate transaction is provided. The method includes contracting with a seller of a property to provide title services for the real estate transaction, and after contracting with the seller but before receiving an offer to purchase the property, providing a first subset of the title services to the seller. The method further includes receiving the offer to purchase the property from a buyer and completing the title services by providing a second subset of the title services to the seller to settle the real estate transaction.

### TECHNICAL FIELD

The present disclosure relates generally to real estate transactions, and more particularly relates to methods for providing title services in a real estate transaction.

### BACKGROUND

Transactions involving real property can frequently involve complexities far beyond those affecting transactions of other types of property. In particular, given the very long title histories for many real estate parcels, title services (e.g., conducting title searches, resolving title issue, underwriting and/or issuing title insurance) can sometimes be particularly complicated and time-consuming. In this regard, the days or even weeks it takes to complete the performance of title services can significantly delay the settlement of a real estate transaction, adding cost and inefficiencies to an already costly and time-consuming process. Accordingly, it is desirable to provide improved methods for providing title services that can reduce these inefficiencies and reduce the time required to settle a real estate transaction.

### BRIEF DESCRIPTION OF THE DRAWINGS

FIG. 1 is a flow chart illustrating a method for providing title services in a real estate transaction in accordance with an embodiment of the present technology.

FIG. 2 is a flow chart illustrating a method for providing title and real estate services in a real estate transaction in accordance with an embodiment of the present technology.

FIG. 3 is a flow chart illustrating a method for providing title services in accordance with an embodiment of the present technology.

### DETAILED DESCRIPTION

In the following description, numerous specific details are discussed to provide a thorough and enabling description for embodiments of the present technology. One skilled in the relevant art, however, will recognize that the disclosure can be practiced without one or more of the specific details. In other instances, well-known methods or operations often associated with title services are not shown, or are not described in detail, to avoid obscuring other aspects of the technology. In general, it should be understood that various other approaches, systems, and methods in addition to those specific embodiments disclosed herein may be within the scope of the present technology.

As discussed above, title services in a real estate transaction can take many days to complete, with the consequence that real estate transactions may endure a long period in escrow following the establishment of a purchase agreement. In this regard, conventional methods for providing title services can frequently add seven to ten days of delay before the settlement of a real estate transaction. To address this and other drawbacks of the conventional approach to providing title services, several embodiments of the present disclosure can provide title services in such a manner to permit accelerated settlement of a real estate transaction, while potentially increasing the marketability of the underlying property offered for sale.

Several embodiments of the present technology are directed to a method for providing title services in a real estate transaction. The method includes contracting with a seller of a property to provide title services for the real estate transaction, and after contracting with the seller but before receiving an offer to purchase the property, providing a first subset of the title services to the seller. The method further includes receiving the offer to purchase the property from a buyer and completing the title services by providing a second subset of the title services to the seller to settle the real estate transaction.

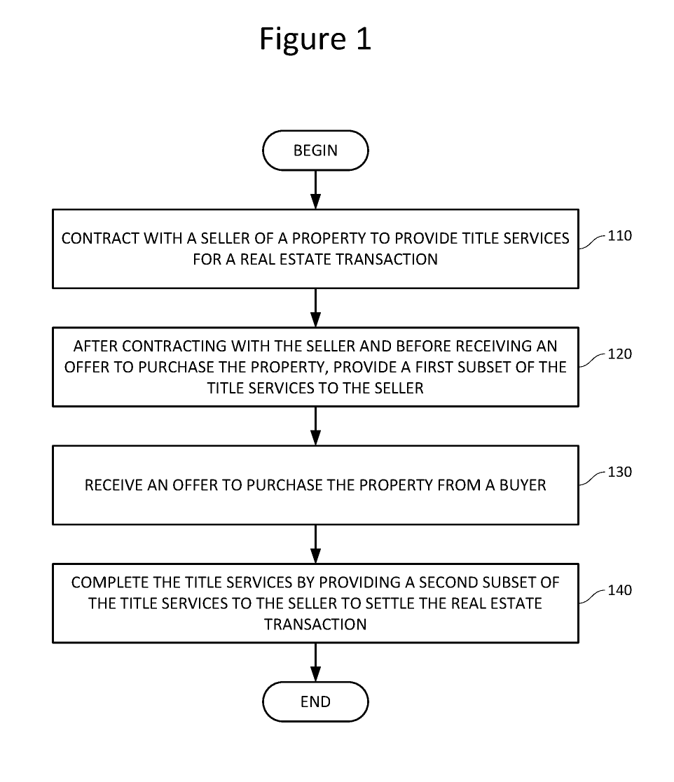

FIG. 1 is a flow chart illustrating a method for providing title services in a real estate transaction in accordance with an embodiment of the present technology. As can be seen with reference to FIG. 1, the method includes contracting with a seller of a property to provide title services for a real estate transaction (box 110). In conventional approaches to providing title services, the selection of a provider of title services for a real estate transaction is usually deferred until after a purchase agreement is contracted between the seller and the buyer of a property. Moreover, although the seller of a property is usually responsible for payment for the title services, no contractual agreement between the seller and the provider of title services is established; rather, the title services are provided after the purchase agreement is established, and payment is collected from the purchase price during the settlement of the transaction without establishing a contractual agreement. In contrast, the approach to providing title services in accordance with the embodiment illustrated in FIG. 1 involves contracting with the seller before, concurrently with, or shortly after the property has been offered for sale, but before an offer to purchase has been received or a purchase agreement has been established.

According to one aspect of the present technology, contracting with a seller of a property to provide title services in a real estate transaction can be performed by an agent of the provider of title services. For example, a real estate agent selected to represent the seller of a property can also act as an authorized agent of the provider of title services to enter a contractual arrangement with the seller on the behalf of the provider of title services. This arrangement can streamline and simplify the process by which a property seller selects a provider of title services, by reducing the number of parties with whom the property seller interacts in the selection of providers for real estate transaction services (e.g., including real estate listing services, title services, etc.).

One benefit of establishing a contractual agreement with the seller of a property to provide title services before a purchase agreement has been established, or before an offer has been received, is the additional time that can be dedicated to performing the title services, concurrently with the marketing of the property for sale (e.g., while the property is advertised, shown, opened for inspection, etc.). Many of the title services provided in a real estate transaction are amenable to provision during this period (e.g., those title services that do not rely upon an identity of the purchaser, or the other particulars of the real estate transaction, such as purchase date, purchase price, etc.). Accordingly, the method illustrated in FIG. 1 continues with the provision of a subset of the contracted title services to the seller before receipt of an offer to purchase the property (box 120). Exemplary title services of this sort can include (i) determining any outstanding tax liability corresponding to the property; (ii) searching public records for documents corresponding to a chain of title of the property; (iii) reviewing the documents corresponding to the chain of title to determine if curative measures are warranted; (iv) performing curative measures to establish a “clean” title; (v) providing a commitment to the seller to issue a title insurance policy; (vi) coordinating procedures for settling the real estate transaction with one or more lienholders of the property; and/or (vii) notifying the seller, real estate agent(s), attorney(s), and/or lienholder(s) of the property that the property is cleared for settlement contingent upon receipt of the offer to purchase the property. Performing these title services in advance of the establishment of a purchase agreement can reduce the time between the establishment of the purchase agreement and the settlement of the transaction, frequently by as much as seven to ten days.

Moreover, once the property has been cleared for settlement, contingent upon receipt of the offer to purchase the property (e.g., “clear to close”), the fact that one or more of the foregoing title services have already been completed can be advertised as a feature of the property. In this regard, advertising that title services have been performed before an offer has been received can add value to the real estate listing, as buyers and sellers frequently desire a shorter escrow period in a real estate transaction. Accordingly, a property for which the foregoing title services have been performed enjoys an increased likelihood of receiving an offer for purchase, such that the next step in the method illustrated in FIG. 1 is the receipt from a buyer of an offer to purchase the property (box 130).

Following receipt of the offer to purchase the property, the remaining title services for which the provider of title services and the seller of the property have contracted may be performed. Accordingly, the next step in the method illustrated in FIG. 1 is the completion of the contracted title services by providing a second subset of title services to the seller to settle the real estate transaction (box 140). These title services, which may include title services for which details from the offer or from a purchase agreement are used, can include: (i) updating title information corresponding to the property based on the offer to purchase the property (e.g., the purchaser, the purchase price, the transaction date, etc.); (ii) preparing title transfer documents for transferring title of the property from the seller to the buyer; (iii) withholding a portion of a purchase price of the property as a payment for the title services and/or other services (e.g., commissions for the provision of real estate services, etc.); (iv) issuing a title insurance policy; and/or (v) settling the real estate transaction (e.g., “closing”).

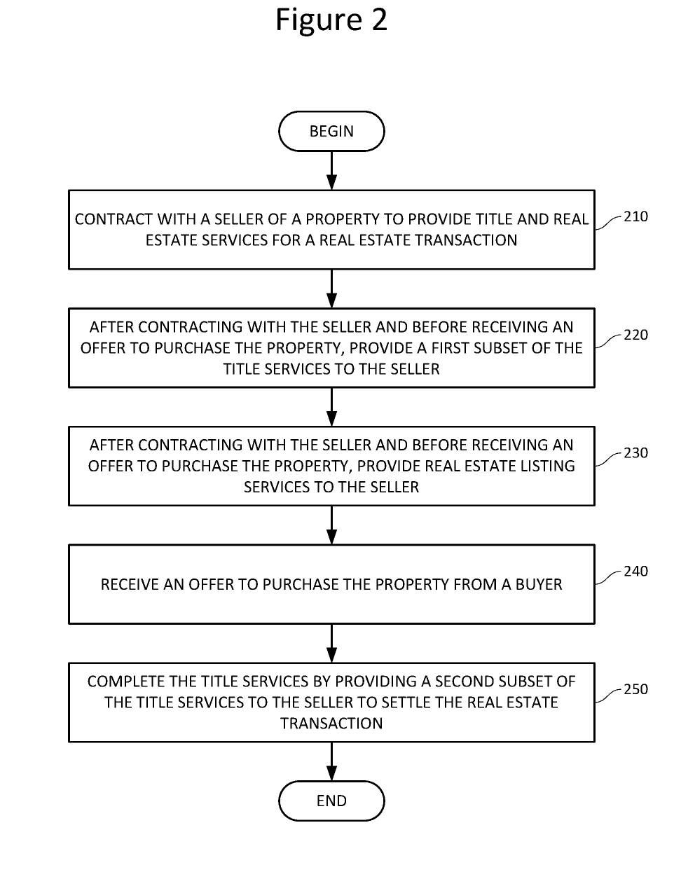

In addition to providing title services in a real estate transaction, various embodiments of the present technology can also optionally involve the provision of real estate services to a property seller. In this regard, FIG. 2 is a flow chart illustrating a method for providing title and real estate services in a real estate transaction in accordance with an embodiment of the present technology. The method includes contracting with a seller of a property to provide title and real estate services for a real estate transaction (box 210). As has been described in greater detail above, contracting with a seller of a property to provide title services in a real estate transaction can be performed by a property seller's real estate agent, who has been authorized to act on behalf of the provider title services to enter a contractual arrangement with the seller. The method of FIG. 2 includes both the provision of a subset of the contracted title services to the seller (as set forth in greater detail above with respect to FIG. 1) before receipt of an offer to purchase the property (box 220), as well as the provision of real estate listing services to the seller (box 230).

In this regard, the real estate listing services provided by the provider of title services to the seller can include: (i) providing photographs of the property (including, e.g., aerial photographs, interior and exterior photographs, virtual reality imaging, etc.); (ii) providing videography of the property (including, e.g., aerial videography, interior and exterior videography, etc.); (iii) providing a virtual tour of the property (e.g., using photos and/or video of the property to generate an interactive multimedia presentation of the property); and/or (iv) providing social media marketing of the property.

The foregoing title services and real estate listing services can increase the marketability and value of the property to a potential buyer. Accordingly, a property for which the foregoing title and real estate listing services have been performed enjoys an increased likelihood of receiving an offer for purchase, such that the next step in the method illustrated in FIG. 2 is the receipt from a buyer of an offer to purchase the property (box 240). Following receipt of the offer to purchase the property, the remaining title services for which the provider of title services and the seller of the property have contracted may be performed to settle the real estate transaction (box 250), as set forth in greater detail above with respect to FIG. 1.

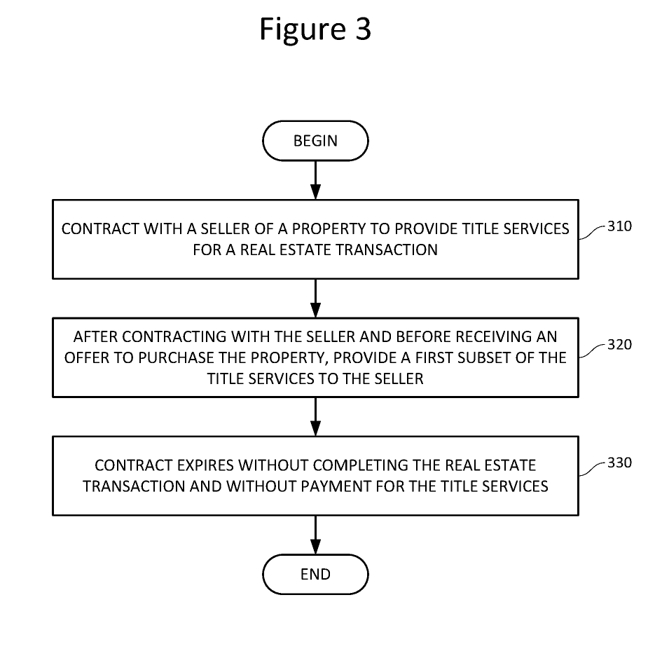

According to one aspect of the present technology, the payment from the seller for title services provided in connection with a real estate transaction can be contingent upon settlement of the real estate transaction. For example, if no offer to purchase the property is made, or if no purchase agreement is established, or if a purchase agreement is not consummated, then the foregoing title services can be provided to the seller without ever collecting payment therefor. In this regard, FIG. 3 is a flow chart illustrating a method for providing title services in accordance with an embodiment of the present technology. The method includes contracting with a seller of a property to provide title and real estate services for a real estate transaction (box 310), and providing a subset of the contracted title services to the seller before receipt of an offer to purchase the property (box 320), as set forth in greater detail above with respect to FIGS. 1 and 2. Should the real estate transaction not be settled within a period specified in the contract between the seller and the provider of title services (e.g., one month, three months, six months, etc.), the method can include the expiration of the contract without completing the real estate transaction, and accordingly without payment for the provided title services (box 330).

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method of providing title services in a real estate transaction, comprising:
contracting with a seller of a property to provide title services for the real estate transaction;
after contracting with the seller and before receiving an offer to purchase the property, providing a first subset of the title services to the seller;
receiving the offer to purchase the property from a buyer; and
completing the title services by providing a second subset of the title services to the seller to settle the real estate transaction.

2. The method of claim 1, wherein the contracting with the seller includes authorizing a real estate agent of the seller to contract with the seller on behalf of a provider of the title services.

3. The method of claim 1, wherein the first subset of the title services includes determining any outstanding tax liability corresponding to the property.

4. The method of claim 1, wherein the first subset of the title services includes searching public records for documents corresponding to a chain of title of the property.

5. The method of claim 4, wherein the first subset of the title services includes reviewing the documents corresponding to the chain of title to determine if curative measures are warranted.

6. The method of claim 5, wherein the first subset of the title services includes performing the curative measures.

7. The method of claim 1, wherein the first subset of the title services includes providing a commitment to the seller to issue a title insurance policy.

8. The method of claim 1, wherein the first subset of the title services includes coordinating procedures for settling the real estate transaction with at least one lienholder of the property.

9. The method of claim 1, wherein the first subset of the title services includes notifying the seller and at least one of a real estate agent, an attorney, and a lienholder of the property that the property is cleared for settlement contingent upon receipt of the offer to purchase the property.

10. The method of claim 1, wherein the second subset of the title services includes updating title information corresponding to the property based on the offer to purchase the property.

11. The method of claim 1, wherein the second subset of the title services includes preparing title transfer documents for transferring title of the property from the seller to the buyer.

12. The method of claim 1, wherein the second subset of the title services includes withholding a portion of a purchase price of the property as a payment for the title services.

13. The method of claim 12, wherein the payment for the title services is contingent upon settling the real estate transaction.

14. The method of claim 1, further comprising:
after contracting with the seller and before receiving an offer to purchase the property, providing real estate listing services to the seller.

15. The method of claim 14, wherein the real estate listing services include providing photographs of the property.

16. The method of claim 14, wherein the real estate listing services include providing videography of the property.

17. The method of claim 14, wherein the real estate listing services include providing a virtual tour of the property.

18. The method of claim 14, wherein the real estate listing services include providing social media marketing of the property.

19. A method of providing title services in a real estate transaction, comprising:
contracting with a seller of a property to provide title services for the real estate transaction; and
after contracting with the seller and before receiving an offer to purchase the property, providing a first subset of the title services to the seller;
wherein payment for the title services is contingent upon settling the real estate transaction.

20. The method of claim 19, wherein the contracting with the seller includes authorizing a real estate agent of the seller to contract with the seller on behalf of a provider of the title services.
